(19) United States
(12) Patent Application Publication
(10) Pub. No.: US 2010/0086744 A1
(43) Pub. Date: Apr. 8, 2010

(54) PRODUCTION OF FILMS FOR COMPOSITE GLAZINGS BY MEANS OF INJECTION MOULDING OR INJECTION STAMPING METHODS

(75) Inventors: Holger Stenzel, Hennef (DE); Andreas Karpinski, Odenthal (DE)

Correspondence Address: BROOKS KUSHMAN P.C., 1000 TOWN CENTER, TWENTY-SECOND FLOOR, SOUTHFIELD, MI, 48075, US

(73) Assignee: KURARAY EUROPE GMBH, Frankfurt am Main (DE)

(21) Appl. No.: 12/597,869

(22) PCT Filed: May 5, 2008
(86) PCT No.: PCT/EP08/55467

§ 371 Date: Oct. 27, 2009

(30) Foreign Application Priority Data
May 3, 2007 (DE) 10 2007 021 103.3

(51) Int. Cl. B32B 3/26; B29C 45/56; C03C 27/04

(52) U.S. Cl. 428/174; 156/100

(57) ABSTRACT

Foils based on softener-containing polyvinyl acetals are produced by injection moulding or injection stamping, and may preferably adopt a wedge-shaped cross-section not possible with extruded foils of polyvinyl acetal. The foils may be moulded to near net shape despite their very high area/thickness ratio, thus avoiding waste.

The invention relates to the manufacture of softener-containing foils on the basis of polyvinyl acetals through injection moulding or injection compression methods.

### TECHNICAL AREA

Foils for laminated safety glazing are popularly manufactured through extrusion methods. During the extrusion, plastics or other viscous materials are pressed through a die in a continuous process. To this end, the plastic—the extrudate—is initially melted and homogenised through an extruder (also called screw press) by means of heating and internal friction. Furthermore, the pressure necessary for the flow through the nozzle is built up in the extruder. Having emerged from the die the molten plastic is cooled via rollers or in a water bath and solidifies into its final form. The foil form is achieved here through simultaneous, continuous pulling off.

### PRIOR ART

As basis for such foils, polyvinyl acetals, more preferably polyvinyl butyrals (PVB) in connection with one or a plurality of softeners are almost exclusively employed. The manufacture more preferably utilises extrusion methods under melt fracture conditions for the specific setting of the surface roughness (e.g. EP 0 185 863 B1). These methods are also employed for manufacturing foils with a colour band; EP 0 177 25 388 for example describes the co-extrusion of two melt flows which can compress different additives and/or pigments into a part-coloured foil.

The foils so obtained have an irregular surface roughness which can subsequently be optionally formed into a regular texture through mechanical compression (EP 0 611 21 63, EP 0 611 21 59).

To manufacture PVB foils for laminated glazing, extrusion methods are employed on a large scale and supply foils with a width of up to 3.20 m and a length of up to 1000 m. During the manufacture of laminated glazing, foil pieces (sheets) of appropriate size are cut from the foil webs. As a result, large quantities of off-cuts (so-called trimmings) are obtained during the manufacture of (non-rectangular) windscreens.

The cutting to size of the foil or the cutting to the required shape of the glass panes is an expensive process step. In addition, the trimmings either have to be disposed of or recycled at the foil manufacturer which in both cases is cost-intensive.

### Object

The object of the present invention therefore was to provide a method for the manufacture of foils for laminated glazing with which foils with predetermined shape and size can be manufactured without the popular extrusion technology.

To manufacture formed parts from thermoplastics injection moulding or injection compression methods are known from other technical areas.

Injection moulding, (also described as injection moulding method) is a forming method which is mainly employed in the processing of plastic. With these methods it is possible to economically produce formed parts that can be directly used in large quantities. To this end, using an injection moulding machine, the respective material or the moulding compound is plasticized in an injection unit and injected into an injection mould. The hollow space, i.e. the cavity of the mould, determines the shape and the surface texture of the finished part. Today, parts of a few tenths of a gram to such in the two-digit kilogram range can be produced.

Injection moulding allows the manufacture of objects with high accuracy such as for example for precision engineering and/or mass products in a short time. Here, the surface of the component can be almost freely selected. Smooth surfaces for optical applications can be manufactured as can grainings for tactile-friendly areas, patterns or engravings. The injection moulding method however is only economically practical for larger quantities since the costs for the mould make up a major part of the required investments. Even with simple moulds the threshold of economy is only reached at a few thousand parts. On the other hand, the moulds, dependent on the moulding compounds used, can be used for the manufacture of up to several million parts.

However, these methods are not generally utilised for the manufacture of foils since the surface to volume ratio with foils is extremely unfavourable.

EP 0 640 460 and AT 56179 describe methods for the injection moulding of foils without designation of the materials used. Since softener-containing PVB has very high melt viscosities even at processing temperatures of 200° C. and only low shape retention even when cooled, injection moulding methods for softener-containing PVB have not been investigated yet.

Surprisingly it was found that foils or foil sheets based on softener-containing polyvinyl acetals such as polyvinyl butyral (PVB) can be manufactured in almost any shapes, sizes and colour arrangements through injection moulding or injection compression methods.

### PRESENTATION OF THE INVENTION

The subject matter of the present invention therefore is a foil based on softener-containing polyvinyl acetals manufactured through injection moulding or injection compression and/or a suitable method for this.

With the method according to the invention a compound based on softener-containing polyvinyl acetal is moulded into a foil through injection moulding or injection compression. The method according to the invention and the machines and techniques useable for manufacturing the foil according to the invention are explained in more detail in the following.

A conventional screw piston injection moulding machine draws the compound based on softener-containing polyvinyl acetals in form of a granulate from a hopper into the screw channels, then divides and shears it. The resultant friction heat together with the heat supplied by the heated cylinder ensures a relatively homogenous melt. This melt collects in front of the tip of the reverse-rotating screw.

In the so-called injection phase the screw is subjected to pressure at the back hydraulically or through mechanical force. In the process, the melt is pressed under high pressure (mostly between 500 and 2000 bar) through the non-return lock, the die pressed against the mould, if applicable a hot runner system (usual with modern series production moulds) and the sprue into the shaping hollow space of the temperature-controlled injection mould. Reduced pressure acts as post-pressure on the melt until the connection (sprue) has solidified (frozen). As a result, the volume shrinkage which develops during cooling is largely offset. Dimensional stability and the desired surface quality are achieved through this measure. After this, screw rotation commences. While the shot weight for the following foil is prepared in this manner, the foil can still cool down in the mould until the core (liquid core) has solidified. The mould opens and ejects the finished foil.

During this, the sprue can be cut off. Injection moulding without sprue is also possible with appropriate sprue configuration. The foils fall from the mould or are taken from the mould with handling devices and put down in an orderly manner or directly passed on for further processing.

Injection compression is modified injection moulding, wherein the plastic melt as so-called compound cake is injected into the practically pressureless not completely closed mould. Under the effect of the locking pressure that develops after injection the moulding is finally moulded. With one version the cavity can be completely filled. The rising internal pressure opens the mould by a controlled minor distance. By raising the locking force the pressure is exerted on the moulding compound and a relatively low-stress moulding moulded. This version for example is used in the manufacture of mouldings of polycarbonate (PC) such as CDs or DVDs or plastic discs. Injection compression is used for thermoplastics and thermosetting plastics. Injection compression is possible on machines of all types. The work sequence can be particularly easily controlled on the locking side on machines with fully hydraulic locking systems. The fibre orientation that occurs with fibre-reinforced moulding compounds during the injection moulding process is partially eliminated during injection compression. Injection compression supplies mouldings with a very good surface and low mechanical anisotropy with all plastics.

The injection compression method can be practically employed when, as in the present invention, long flat parts with an unfavourable wall thickness-flow distance ratio and distortion-prone parts are to be manufactured. Parts with maximum precision can be produced. High-strength parts with a high surface quality and very good dimensional accuracy are obtained since during the compression process the mouldings in the mould cavity are compressed to a degree that is not possible via the sprue paths even with maximum injection pressure. Consequently they have a more homogenous structure than normally injected items so that with this method for example optical lenses and prisms can be produced.

The injection compression method is particularly suitable for the manufacture of polyvinyl acetals/PVB foil sheets according to the invention, since the wall thickness-area and thus also the wall thickness-flow distance ratio are unfavourable and in the conventional injection moulding process could lead to very high injection pressures. This effect is reinforced through the relatively high melt viscosities softened PVB has at processing temperatures around 200° C. The advantage of the low-stress quality during injection compression does not benefit PVB since PVB is an amorphous material.

Foils or foil sheets according to the invention can have any shape, more preferably that of a windscreen in the automotive or aircraft section. FIG. 1 shows a usual shape of a windscreen in schematic view. The thickness of the foils according to the invention, provided the foil is plane-parallel, usually amounts to multiples of 0.38 mm such as 0.76 mm or 1.14 mm etc.

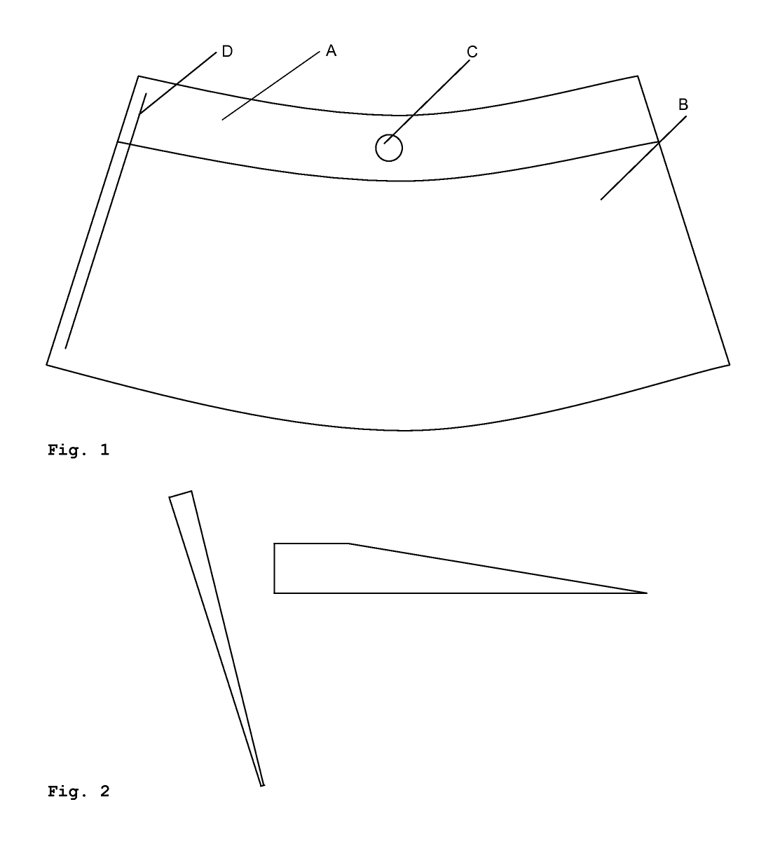

Thus the invention consists in producing foils through injection moulding or injection compression methods. In this manner, foils can more preferably be produced which by the (more cost effective) extrusion method cannot be manufactured or only with very high expenditure. These can for example be foils whose thickness is variable across the width, i.e. have a wedge-shaped cross section (FIG. 2 shows a cross section of such foils).

Foils manufactured according to the invention can have a wedge-shaped cross section corresponding to an angle of approximately 0.1 to 1 mrad, preferably 0.3 to 0.7 mrad and more preferably 0.4 to 0.6 mrad.

Wedge-shaped foils are used for the projection in head-up displays and are for example described in EP 0 893 726 B1. With projection on laminated glazing, which consists of two glasses joined by a PVB foil, interfering dual images normally occur. This negative effect is prevented in that the foils are embodied a few arc minutes wedge-shaped and then both images are located on top of each other.

By means of the injection moulding or injection compression technology according to the invention almost any course of the foil thickness can be created. In its outer dimensions, the sheet produced can be exactly matched to the geometry of the windscreen or, if applicable, with a predefined protrusion.

This is more preferably of importance when it concerns foil with a colour band, i.e. with coloured and plain part regions. Such—wedge-shaped or plane-parallel—foils are used in automotive manufacture and in the upper part of the foil have an approximately 5-90 cm, preferably 10-25 cm wide coloured part region, a so called colour band, with a residuary of the foil in a different colour or plain. FIG. 1 shows such a foil wherein (A) designates a coloured and (B) a plain part region.

As a rule, foils of this type are stretched on one side by the manufacturer of the windscreens in order to have the colour band run parallel with the upper edge of the not usually rectangular windscreen. Through the stretching operation, the thickness profile of the foil is likewise changed, which with foils with wedge-shaped cross section can have a negative effect on the wedge profile.

This stretching operation is not required with injection moulded or injection compressed foils according to the invention. The injection moulding or injection compression method according to the invention is therefore particularly suitable for foils with wedge-shaped cross section with colour band e.g. for head-up display applications. According to the extrusion method, such foils can only be produced with major expenditure and subsequently have to be subjected to a further process step, the one-sided stretching.

However, there are also additional PVB foil requirements which practically exclude manufacture through the conventional, continuous extrusion methods. In modern vehicles for example, sensors are ever more frequently attached in the upper region behind the windscreen which in twilight automatically switch on the headlights or the windscreen wipers if it starts to rain, i.e. so called light and rain sensors respectively. If the colour band covers these sensors this function can be restricted or become impossible if the sensors operate in a wavelength range that is filtered out by the colour band. This can be the case both in the visible range of light, i.e. in the wavelength range from 400-780 nm, as well as in the near IR-range above 800 nm. In the region of the sensors a plain or transparent region must then be worked into the coloured region of the foil (i.e. in the colour band) (so called sectorial transparency). The manufacture of such a foil is not possible by the continuous extrusion method, since here only continuous regions of a foil deviating from other regions in respect to colour or the formulation can be produced.

However, this is possible with the injection moulding or injection compression method according to the invention. By means of these, foils can be produced which in coloured part regions have plain, differently coloured or weaker coloured regions or coloured regions in plain part regions. The shape and size of these regions is dependent on the respective application and can for example island-like occupy an area of a few cm².

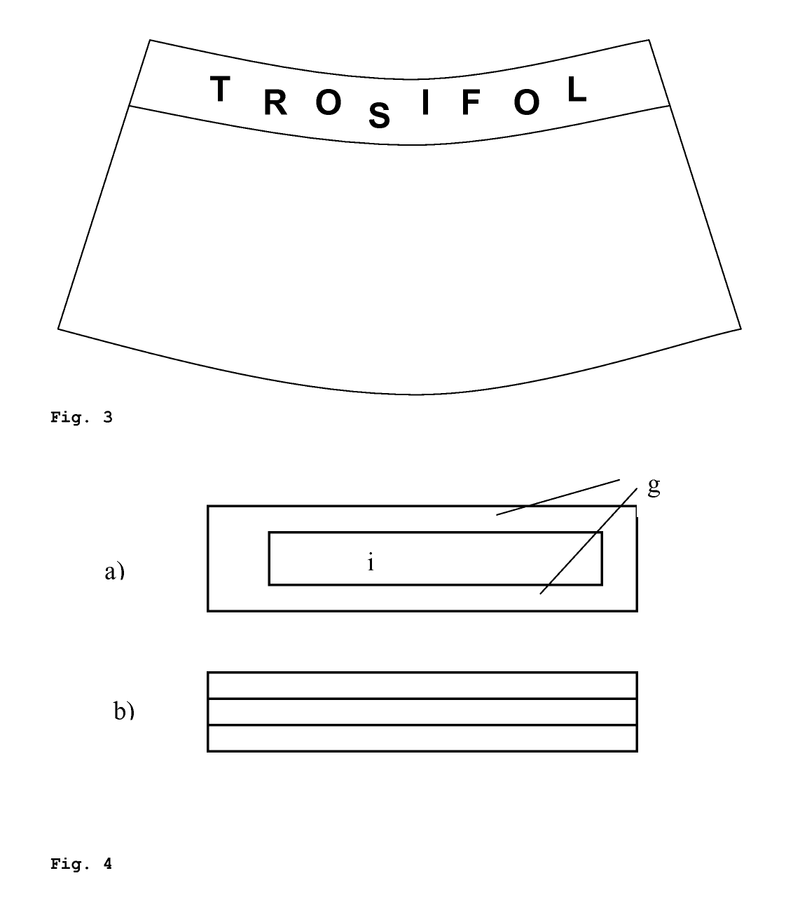

FIG. 1 shows a foil with a coloured part which region (A) and a plain part region (B). The region (C) is not or only slightly coloured and serves for covering a sensor which would not be able to operate through the coloured part region (A). (D) designates an aerial incorporated in the foil. The more likely coloured or differently coloured or plain regions arranged in coloured or plain part regions can have any conceivable geometrical shape which can also merely have decorative character. FIG. 3 for example shows a foil with a plain or differently coloured colour band in a (coloured) colour band such as for example black writing in red colour band.

In order to produce foils with colour band, one can make use of a version of the method according to the invention, the two-component injection moulding method, briefly called 2C method.

With the 2C method there are various types of injection moulding all of which have in common that injection moulding machines with two injection units but only one locking unit are required. The injection units have to operate in harmony but always be controllable independently of one another. The components can be injected through a special die or be incorporated in the mould at various points. Obviously it is also possible to use more than two components. This is then called multi-component method which in principle can be differentiated as follows:

1. Multi-component Method with Clearly Distinguished Components

Parts with strictly separated component regions are produced here. This is brought about through:

### A) Repositioning Technique

Repositioning of the unfinished injection moulding in a mould cavity with space for the new component with the help of a handling device, robot or operating person. Techniques of this type are for example employed to manufacture view windows in device housings.

### B) Turning/displacing Technique

Turning (turning technique) or displacing (displacing technique) of a mould part into a new position (usually a mould half is turned/moved). Exemplary application: toothbrushes (turning or displacing), parts with hard carrier and soft surface or multi-coloured light screens of modern vehicles.

A special form of the turning/displacing technique is the reversing plate technique. With the reversing plate technique, two opposite injection units are used both of which are positioned in the centre axis of the machine. The first injection unit is conventionally arranged, the second one is located behind the moveable mounting plate and is moved together with the latter. Between the fixed and the moveable mounting plate is located a sliding table which can be moved on linear guides with hydraulic cylinders. A rotatable reversing plate is mounted on this sliding table which carries the mould. Through 180°- or 90° turning about the vertical axis, the mould sides can be alternately filled with material from the two injection units.

### C) Core Retraction Technique

Here, a core is retracted in the mould following the filling in of a compound in order to create space for another newly added component. Frequent application: device housing with different colour regions.

### D) Multi-colour Method

Here, different colours of the same material are processed in one part. This application is used for instance with multi-colour car back lights.

### E) Multi-component Method

Here, different materials such as with hard-soft bonds are processed in one part. Examples are closing caps with moulded-on soft seals.

2. Multi-component Method with Spreading Components

Here, parts are produced with components spreading into one another. The following process versions are known:

### A) Sandwich Method

Here, parts are mostly created where the component located in the interior is not visible since it is entirely enveloped by the external material. Frequently recycled material as invisible component is employed with this method. The internal material can also be foamable. High-quality material is then employed as outer skin. During sandwich injection moulding, the source flow of the compounds is utilised during the inflow in the mould nest. The melts successively fill the cavity from the gate. The mould compounds inflowing first continuously settles on the wall to which it is last pushed by the second component flowing in the interior. Two injection units operate together on an injection head which depending on the controlling through valves or multiple closing dies allows any inflow of the compounds from all injection units. The source flow ensures that this complete enveloping of each other of the components perfectly succeeds up to the smallest wall thicknesses. The sprue can be sealed through the first component.

A further subject of the present invention therefore are multi-layer foils constructed of at least two layers based on softener-containing polyvinyl acetals wherein at least one layer is produced through injection moulding or injection compression. Here it is possible that a foil conventionally produced through extrusion is over-moulded with at least one additional layer. Preferably however the layers based on softener-containing polyvinyl acetals are produced simultaneously or successively through injection moulding or injection compression in the same mould.

FIG. 4 shows schematically a multi-layer foil according to the invention, wherein FIG. 4a) sketches a complete inner layer (i) encapsulated by two outer layers (g). Compared with the outer layers the inner layer can have different polyvinyl acetals, different type and/or quantities of softener and/or dyes or pigments for a colour band. FIG. 4b) shows a multi-layer foil with continuous layers which are for example suitable for sound damping.

In the present invention, multi-layer foils can thus be produced with 2, 3, 4 or more layers wherein the layers for example have chemically different polyvinyl acetals or polyvinyl butyrals and/or different types or quantities of softeners.

### B) Marbling

Colour artificial flower leaves and artificial adornment are examples of marbled parts. Here, the alternating components (mostly it concerns the same material but in different colours—but at any rate the materials must be highly compatible) are also visible on the surface. This is achieved through intermittently commencing injection units. Such a technique can more preferably be employed for foils in laminated glazing with decoration.

These techniques are generally known for producing mouldings and can also be employed for producing foils according to the invention or in the method according to the invention.

In order to produce foil sheets with colour band according to the invention with sectorial transparency the multi-colour method with core retraction technique or displacement technique/reversing plate technique can preferably be employed. Here, the transparent melt is initially injected into the mould and cooled down. Following this, an additional cavity for the colour region is exposed through a moveable core or slide into which the colour melt is then injected. With the injection compression method the reversing plate technique can additionally be employed since this technology makes it possible to combine 2C injection moulding and compression on one machine.

Through appropriate texturing of the surface of the injection mould the surface roughness of the foil required for the ventilation in the lamination process later on (see EP 1 235 683 B1) during the laminated glass production can be directly created during the injection moulding or injection compression operation. For the improved demouldability of the foil sheet the mould surface can be provided with an anti-adhesive layer. Layers based on PTFE have proved to be suitable for this.

By using the injection moulding or injection compression method for producing foil sheets according to the invention it is also possible to work components of other materials (e.g. metals or fibres) into the foil. Thin wires, which later assume the function of an aerial or heater in the windscreen can be introduced into the cavity and subsequently over moulded with the melt.

Thus, foils according to the invention can have inserts for example of metal foils, metal wires, metal netting, polymer foils, polymer fibres, polymer netting and/or liquid crystals.

The combination of two or more embodiments of the foil according to the invention is possible in a simple manner through the application of injection moulding or the injection compression according to the invention. In only one operation, a wedge-shaped, surface-textured foil adapted to the windscreen geometry with colour band, sectorial transparency and worked-in aerial can thus be produced.

In all versions of the method according to invention the melt of the softener-containing PVB can be injected into a cold mould with a temperature of for example 10-100° C.

To improve the flow capacity of the material in the mould this can also be temperature controlled (so called variotherm method). When injecting the material, the mould temperature can be set to 150 to 200° C. To facilitate the removal of the moulding it is optionally possible to subsequently cool the mould down to 10 to 50° C.

Alternatively to this version of the method according to the invention the moulding can also be taken from the mould with a flat removal tool cooled to this temperature.

The foils according to the invention contain polyvinyl acetals, more preferably one or a plurality of part-acetalised polyvinyl alcohols and/or one or a plurality of part-acetalised vinyl alcohol/vinyl acetate/ethylene terpolymer. In addition to non-subponified acetate groups, these polymers have hydroxyl groups bound to the polymer chain (backbone) which wholly or partly are acetalised with one or a plurality of aldehydes. The production of the polyvinyl acetals employed according to the invention is known to the person skilled in the art.

As vinyl alcohol/vinyl acetate/ethylene terpolymers, EXEVAL or EVAL of Kuraray Co. (Japan) can more preferably be employed.

As aldehydes, preferably such with one to 10 carbon atoms such as for example formaldehyde, acetaldehyde, propionaldehyde, butyraldehyde or octanal are employed. Butyraldehyde is more preferably preferred which leads to the known polyvinyl butyral (PVB).

Suitable polyvinyl butyrals have a residual vinyl alcohol content according to ASTM D 1396 of 16 to 25% by weight, more preferably 16 to 20% by weight. Suitable polyvinyl butyrals are for example described in WO 03/051974 A1 or EP 1 412 178 B1. The compounds used according to the invention are produced by adding suitable softeners to polyvinyl acetals. Alternatively the use of internally plasticised polyvinyl acetals, i.e. polyvinyl acetals with suitable covalent-bonded side chains are possible.

It is also possible to use polyvinyl butyrals cross-linked with dialdehydes or aldehyde carbonic acids. Suitable polymers of this type are described in DE 10 143 109 A1 or WO 02/40578 A1.

Usually, the thermoplastic moulding compounds used according to the invention contain 10-40% by weight of one or a plurality of softeners.

As softener for the polyvinyl acetal, the “standard softeners” known for the manufacture of laminated glass laminates such as Diethyleneglycol-di-2-ethylhexanoate Triethyleneglycol-di-2-ethylbutyrat (3GH), Triethyleneglycol-di-n-hexanoate (3G6), Triethyleneglycol-di-n-heptanoate (3G7), Triethyleneglycol-di-2-ethylhexanoate, Triethyleneglycoloctanoate, Tetraethyleneglycol-di-2-ethylhexanoate (3G8), Dihexyladipate (DAH), Dialkyladipate with an alkyl residuary with more than 6 carbon atoms and oligoglycol acid ester with a carbonic acid residuary with more than 7 carbon atoms more preferably dioctyladipate (DOA), etc. can be used.

Furthermore, softeners of the formulas I and/or II

R1—O(—R2—O)ₙ—CO—R5 I

R1—O(—R2—O)n—CO—R3—CO—(O—R4—)ₘO—R6 II

with R1,R5,R6: independent of one another H, aliphatic or
aromatic residuary with 1 to 12 C-atoms,
R3: smooth bond, bi-valent aliphatic or aromatic residuary with 1 to 12 C-atoms
R2, R4: independent of one another bi-valent aliphatic or aromatic residuary with 1 to 12 C-atoms
n, m: indepedent of one another entire numbers from 1 to 10, more preferably 1 to 5
   are suitable.

Preferably R2 and R4 stand independent of one another for ethylene, propylene or butylene residuaries, i.e. the softeners contain units formed through ethylene, propylene or butylene oxide or their oligomers. R1, R5 and R6 independent of one another mean preferably methyl, ethyl, propyl, butyl or hexyl residuaries.

The carbonic acids of the esters according to Formula I are more preferably benzoic acid, cyclohexane carbonic acid, acidic acid, propionic acid and carbonic acids with 4-18 carbon atoms. The following dicarbonic acids are prefered as carbonic acid component of the esters according to Formula II: oxalic acid, malonic acid, glutaric acid, succinic acid, adipic acid, pimelic acid, azelaic acid, sebacic acid, terephthalic acid, phthalic acid, isothalic acid as well as all stereo isomers of the cyclohexane dicarbonic acid.

The group of these softeners include for; example Di-(2-butoxyethyl)-adipate (DBEA), Di-(2-butoxyethyl)-sebacate (DBES), Di-(2-butoxyethyl)-azelate, Di-(2-butoxyethyl)-glutarate. Di-(2-butoxyethoxyethyl)-adipate (DBEEA), Di-(2-butoxyethoxyethyl)-sebacate (DBEES), Di-(2-butoxyethoxyethyl)-azelate, Di-(2-butoxyethoxyethyl)-glutarate, Di-(2-hexoxyethyl)-adipate, Di-(2-hexoxyethyl)-sebacate, Di-(2-hexoxyethyl)-azelate, Di-(2-hexoxyethyl)-glutarate, Di-(2-hexoxyethoxyethyl)-adipate, Di-(2-hexoxyethoxyethyl)-sebacate, Di-(2-hexoxyethoxyethyl)-azelate, Di-(2-hexoxyethoxyethyl)-glutarate, Di-(2-butoxyethyl)-phthalate and/or Di-(2-butoxyethoxyethyl)-phthalate.

The foils according to the invention can exclusively contain one or a plurality of compounds of the Formula I or II as softener. It is also possible to employ softener mixtures of the mentioned “standard softeners” and softeners of the Formulas I and/or II. Such moulding compounds contain
a) 60 to 85% by weight of polyvinyl acetal
b) 14 to 39% by weight of at least one “standard softener”, and
c) 1-20% by weight, preferably 2-10% by weight of at least one co-softener of the Formulas I and/or II
   The details in % by weight refer to the total recipe.

Foils according to the invention can contain additional additives known to the person skilled in the art such as residual quantities of water, UV-absorber, antioxidants, adhesion regulators (e.g. sodium and/or magnesium salts), visual brighteners, stabilisers, colorants, processing aids and/or surface-active substances. Systems of this type are described for example in EP 0 185 863 A1, WO 03/097347 A1 or WO 01/43963 A1.

Processing of the foils according to the invention into laminated safety glass can be performed as is usual in laminated glass production through vacuum bag method or pre-lamination/autoclave processes. Here, the foil is placed between two glass panes and the enclosed air largely removed through the application of vacuum or external pressure. The pre-lamination so obtained can subsequently be compressed into a transparent laminated glass in an autoclave under increased pressure and increased temperature.

Alternatively, single-stage processes can also be carried out wherein a glass/foil laminate put together is compressed under the effect of vacuum and processed at elevated temperatures (approx. 100-150° C.) into a transparent bubble-free laminated glass.

1-10. (canceled)

11. A non-continuous foil having defined boundaries as produced, comprising at least one softener-containing polyvinyl acetal, the foil produced in a mould through injection moulding or injection compression moulding.

12. The foil of claim 11, wherein the foil has a wedge-shaped cross-section.

13. The foil of claim 11, wherein the foil has partial regions with a different coloration than another region.

14. The foil of claim 12, wherein the foil has partial regions with a different coloration than another region.

15. The foil of claim 13, wherein a coloured partial region has differently coloured or plain regions.

16. The foil of claim 13, wherein plain partial regions have coloured regions.

17. The foil of claim 11, further comprising at least one insert of metal foil, metal wire, metal netting, polymer foil, polymer fibre, polymer netting, and liquid crystals.

18. The foil of claim 11, wherein a partially-acetalised polyvinyl alcohol and/or a partially-acetalised vinyl alcohol/vinyl acetate/ethylene terpolymer is used as a polyvinyl acetal.

19. A method for the manufacture of a foil for laminate glazing, comprising injection moulding or injection compression moulding of a composition comprising a softener-containing polyvinyl acetal.

20. A multi-layer foil, comprising at least two layers of softener-containing polyvinyl acetals, wherein at least one layer is produced through injection moulding or injection compression moulding.

21. A multi-layer foil of claim 20, wherein the layers comprising softener-containing polyvinyl acetals are manufactured simultaneously or successively through injection moulding or injection compression in the same mould.

22. A method for producing a laminate glazing, comprising injection moulding or injection compression moulding of a composition comprising a softener-containing polyvinyl acetal to form a foil, placing the foil between two layers of glass, and heating to form an integral laminate glazing.

23. The foil of claim 11, which is to be used as a glazing foil, and is moulded at net shape or near net shape of a glazing laminate to be produced.

24. The foil of claim 23, wherein the thickness of the foil is 0.38 mm or an integral multiple thereof.

25. The foil of claim 23, which is wedge-shaped at least in part.
